(19) United States
(12) Patent Application Publication
(10) Pub. No.: US 2003/0203821 A1
(43) Pub. Date: Oct. 30, 2003

(54) Stable liquid suspension compositions and method of making

(76) Inventor: Kelly B. Fox, Bartlesville, OK (US)

Correspondence Address: Rodney B. Carroll, Conley Rose, P.C., 5700 Granite Parkway, Suite 330, Plano, TX, 75024, US

(21) Appl. No.: 10/132,625

(22) Filed: Apr. 25, 2002

(51) Int. Cl. C09K 7/00

(52) U.S. Cl. 507/100

(57) ABSTRACT

A process is provided for a method a preparing a novel non-aqueous suspension which can be used as additives in a water-based fluids. Water-based fluids such as, for example, drilling fluids and mining fluids, are useful in a variety of industrial applications. Thus, because of the particular properties of the inventive non-aqueous suspension described, it can suitably be used as an additive to oil and gas well treatment fluids by admixing with a water-based fluid in such manner as to form an admixture. A method is disclosed for the introducing the admixture into a wellbore.

### FIELD OF THE INVENTION

This invention relates to novel liquid suspension compositions, which can be used as additives in a water-based fluids, and methods of making and using of such liquid suspension compositions. More specifically, this invention relates to a novel liquid suspension composition with the addition of a dispersant such as calcium state or lecithin to improve the stability of such liquid suspension.

### BACKGROUND OF THE INVENTION

Water-based fluids such as, for example, drilling fluids and mining fluids, are useful in a variety of industrial applications. It is well known to those skilled in the art of drilling wells to tap subterranean deposits of natural resources such as gas, geothermal steam or crude oil, especially when drilling by the rotary method or the percussion method wherein cuttings must be removed from the bore hole, that it is necessary to use a drilling fluid.

The use of water-based fluids in stimulation, workover and completion fluids in oil field operations is also well known. Workover fluids are those fluids used during remedial work in a drilled well. Completion fluids are those fluids used during drilling and during the steps of completion of the well.

Additives, chemicals, or other materials are often added to such water-based fluids for various reasons such as for controlling water loss, increasing viscosity, reducing corrosion, altering pH, and increasing density of the fluids. However, the addition of such materials to water-based fluids can be difficult unless proper precautions are taken to preclude agglomeration or plugging.

Liquid additives and processes therefor have been developed to overcome some of the problems. However, the hydrocarbons and other compounds used as the liquid medium of such stable liquid additive suspensions may not be environmentally friendly; because, they are often not biodegradable or because their use in drilling and well treatment fluids may result in noncompliance with EPA oil and grease effluent limitations.

It is, therefore, highly desirable to develop a liquid suspension composition which remains stable, useable as an additive in water or water-based fluids, and which is environmentally friendly for use in oil field applications.

### SUMMARY OF THE INVENTION

It is thus an object of this invention to provide a stable liquid suspension composition which is environmentally friendly and useful in oil field applications.

Other aspects, objects, and the several advantages of the invention will become more apparent in light of the following disclosure.

According to a first embodiment of the invention, a stable liquid non-aqueous liquid suspension is provided. The non-aqueous suspension composition comprises non-soluble particles that are dispersed in a non-aqueous liquid medium. The non-aqueous medium has a concentration of a suspension aid and a dispersant. The non-aqueous liquid medium is selected from the group consisting of glycols, polyglycols, glycol ethers, glycol esters and glycol ether esters. The suspension aid is selected from the group consisting of hydroxypropyl cellulose, ethyl cellulose, polyvinyl pyrrolidone, polyacrylic acid, and copolymers of polyvinyl pyrrolidone and acrylic acid. The dispersant is selected from a group consisting of calcium sterate, lecithin, steric acid, oleic acid and palmetic acid, and other salts of fatty acids.

In a second embodiment of the invention, a non-aqueous suspension is prepared by mixing non-soluble particles, a suspension aid, a dispersant and a liquid medium to thereby form the non-aqueous suspension. The liquid medium is selected from the group consisting of glycols, polyglycols, glycol ethers, glycol esters and glycol ether esters. The dispersant is selected from the group consisting of calcium sterate, lechithin, steric acid, oleic acid and palmetic acid, and other salts of fatty acids.

### DETAILED DESCRIPTION OF THE INVENTION

In accordance with the present invention, the novel non-aqueous suspension medium comprises, consisting essentially of, or consists of a non-aqueous liquid medium having dissolved therein a concentration of a suspension aid, a dispersant and having dispersed in such liquid medium non-soluble particles. The non-aqueous liquid suspension may also be described as comprising, consisting essentially of, or consisting of a liquid medium, non-soluble particles, a dispersant, and a stabilizing amount of a suspension aid sufficient to enhance the stability of the suspension of non-soluble particles in the liquid medium.

As referred to herein, the term “non-aqueous” means, unless otherwise indicated, a liquid that contains a minor amount of water, but, preferably, the liquid is one that is substantially free of water. The minor amount of water in the non-aqueous suspension medium is a concentration of water that is low enough to assure that the inventive non-aqueous suspension maintains the fluid properties of a stable suspension. A minor amount of water is generally less than about ten weight percent (10%) of the non-aqueous liquid medium. Thus, a minor amount of water will be in the range upwardly to about ten weight percent (10%). As noted, it is preferred for the non-aqueous liquid of the invention to be substantially free of water. Therefore, the non-aqueous liquid medium of the invention can have less than about one weight percent (1%) water, preferably, the amount of water is less than about 0.5 weight percent, and, most preferably, the amount of water is less than 1000 parts per 5 million by weight (ppmw).

An important aspect of this invention is for the non-aqueous liquid medium to be an environmentally friendly compound. That is, a compound that is readily biodegradable when exposed to the environment and which passes the so-called oil and grease test by not being extractable from water by use of the extraction solvents as described in EPA Method 413.1 and EPA Method 1664.

Any suitable material that is in the liquid phase at ambient conditions, typically at temperatures between −30° C. to 50° C., preferably, between −20° C. to 40° C., and meets the above described criteria can be used as the non-aqueous liquid medium of the suspension composition of the invention so long as it forms a stable liquid suspension of the non-soluble particles when combined with the non-soluble particles and the suspension aid. The non-soluble particles and suspension aid are more fully defined elsewhere herein. Among the non-aqueous liquid medium compounds are those chemical compounds selected from the group consisting of glycols, polyglycols, glycol ethers, glycol esters and glycol ether esters.

Each glycol or polyglycol compound suitable for use as the non-aqueous liquid medium of the invention should have a molecular weight greater than about 100; because, those compounds that have molecular weights below about 100 tend to undesirably solvate the suspended particles. However, due to the requirement that the non-aqueous liquid medium be in the liquid phase at ambient temperatures, its molecular weight should be less than about 4,000. Therefore, suitable glycols and polyglycols can have a molecular weight in the range of from about 100 to about 4,000, preferably from about 100 to about 3,000, and more preferably, from about 100 to 2,750.

The glycols that can be used as the non-aqueous medium have the following general formula:

H—O—R₁—O—H

where R₁ is an alkyl group having from 4 to 8 carbon atoms, preferably, from 3 to 4 carbon atoms. Examples of suitable glycols include butylene glycol, 1,5-pentanediol and hexylene glycol.

The polyglycols that can be used as the non-aqueous medium have the following formula:

H—[O—R₁]ₙO—H

where R₁ is an alkyl group having from 1 to 6 carbon atoms, preferably, from 2 to 4 carbon atoms. Specific examples of poly glycols that can suitably be used include, but are not limited to, diethylene glycol, triethylene glycol, dipropylene glycol, tripropylene glycol, polyethylene glycol (having a molecular weight between 200 to 4,000), and polypropylene glycol (having a molecular weight between 200 to 4,000). The presently preferred polyglycols for use as the non-aqueous medium are diethylene glycol, triethylene glycol and polypropylene glycol. Polypropylene glycol is particularly preferred because of its commercial availability and effectiveness.

The glycol ethers that can be used as the non-aqueous medium have the following general formula:

R₂[O—R₁]ₙO—R₂

where R₁, is an alkyl group having from 1 to 6 carbon atoms, preferably, from 2 to 4 carbon atoms, and where each R₂ can be the same or different and further 15 where R₂ is either a hydrogen or an alkyl group having from 1 to 10 carbon atoms, preferably, from 1 to 4 carbon atoms. The value for n is an integer in the range of from 1 to 10. Specific examples of glycol ethers which can suitably be used as the non-aqueous medium include, but are not limited to, 2-Butoxyethanol, 2-(2-Butoxyethoxy) ethanol, di(propylene glycol) methyl ether, diethylene glycol dimethyl ether, diethylene glycol ethyl ether, diethylene glycol butyl ether. The presently preferred glycol ethers for use as the non-aqueous liquid medium of the novel suspension composition are diethylene glycol ethyl ether and diethylene glycol butyl ether, and di(propylene glycol) butyl ether. The most preferred glycol ether is diethylene glycol butyl ether.

The glycol esters that can be used as the non-aqueous medium have the following general formula:

R₁[R₂—O]ₙR₃

where R₁, is a carboxyl group having from 1 to 6 carbon atoms, preferably, from 1 to 4 carbon atoms, and where R₂ is an alkyl group having from 1 to 6 carbon atoms, preferably, from 1 to 4 carbon atoms, and where R₃ is either a hydrogen or a carboxyl group having from 1 to 6 carbon atoms, preferably, from 1 to 4 carbon atoms. The value for n is an integer in the range of from 1 to 10. Specific examples of glycol ester compounds that can suitably be used as the non-aqueous liquid medium include, but are not limited to, 1,2-Ethanediol monoacetate and ethylene glycol diacetate.

Examples of glycol ether ester compounds that can suitably be used as the non-aqueous medium include, but are not limited to, 2-ethoxy ethyl acetate, di(ethylene glycol) ethyl ether acetate, di(ethylene glycol) butyl ether acetate and di(propylene glycol) methyl ether acetate.

It is an important aspect of the present invention for the suspended particles of the non-aqueous suspension to be substantially non-soluble, or only partially soluble, in the non-aqueous liquid medium. But, they also must form a relatively stable suspension when mixed in such medium. Thus, the non-soluble particles are solid particulates that are substantially insoluble, or partially soluble, in the non-aqueous liquid medium.

When referring herein to the stability of a liquid suspension, it is understood that a stable liquid suspension is defined as a liquid suspension in which the non-soluble particles remain dispersed in the liquid phase and do not settle out and separate from the liquid phase after a substantial period time has passed. Generally, such time period exceeds 3 days (i.e. 72 hours), but preferably, the non-soluble particles should remain dispersed in the liquid phase, or non-aqueous liquid medium, for a period of time exceeding 5 days (i.e. 120 hours) and, most preferably, the particles should remain dispersed in the liquid phase, or non-aqueous liquid medium, for a period of time exceeding 10 days (i.e. 240 hours).

The non-soluble particles of the inventive composition should have such properties as to permit their suspension in the non-aqueous liquid medium while at the same time being non-soluble in such medium. It is preferred for the average diameter of the non-soluble polymer particles to be in the range from about 50 angstroms to about 2000 microns. The non-soluble polymer particles can be colloidal in size (e.g. from about 50 Å to about 2000 Å), but it is not necessary; provided, that, they are easily dispersed within the non-aqueous liquid medium to form a stable solution when combined with the other components of the suspension composition.

Examples of materials suitable for use as non-soluble particles of the invention composition include various known natural and synthetic polymeric viscosifiers that are commonly used in well treatment fluids; for example, such components include biopolymers, such as xanthan (xanthan gum), cellulose compounds including hydroxyethylcellulose (HEC); carboxylmethylcellulose (CMC); guar gum; starch; derivitized guar; polyacrylamide; and other water soluble synthetic polymers. Also, certain non-polymeric materials can be used as the non-soluble particles of the inventive composition, such as borax and salts of ethylene diamine tetra acetic acid. The preferred material for use as the non-soluble particle of the invention is guar gum, guar derivatives, xanthan gum, cellulose derivatives and synthetic polymers.

Another important component of the non-aqueous suspension is the suspension aid used to provide additional viscosity to the liquid medium so as to assist in keeping the non-soluble particulate material dispersed in the liquid medium. It is essential that the properties of the suspension aid be such that it is soluble. or at least partially soluble, in the non-aqueous liquid medium of the inventive composition while at the same time enhancing the suspendability of the non-soluble particles within the liquid phase of the composition and, thus, the stability of the inventive composition. It has been found that small concentrations of the compounds of hydroxylpropylcellulose (HPC), ethyl cellulose, polyvinyl pyrrolidone, polyacrylic acid, or copolymers of polyvinyl pyrrolidone and acrylic acid assist in significantly enhancing the stability of the non-aqueous suspension. Thus, an essential feature of the inventive composition is for the non-aqueous liquid medium to contain a concentration of either hydroxypropyl cellulose, or ethyl cellulose, or polyvinyl pyrrolidone, or polyacrylic acid, or a copolymer of polyvinyl pyrrolidone and acrylic acid in such an amount that it is sufficient to enhance the stability of the suspension of the non-soluble particles in the non-aqueous liquid medium of the inventive composition. The preferred suspension aid is hydroxypropyl cellulose.

Based on the total weight of the non-aqueous liquid suspension composition of the present invention, the suspended non-soluble particles in the total suspension composition solution can be present in any weight percent provided the suspension is stable. Generally, however, the weight percent of suspended particles in the total suspension composition can be in the range from about 10 weight percent to about 70 weight percent, preferably, from about 20 weight percent to about 60 weight percent and, most preferably, from 20 weight percent to 50 weight percent.

As for the concentration of the suspension aid in the non-aqueous suspension composition, it must be present in the non-aqueous liquid medium in an amount and at a concentration sufficient to provide the necessary function of enhancing the stability of the suspended particles in the liquid phase of the suspension composition. It has been found that a concentration as a percentage of the total weight of the non-aqueous suspension composition of at least 0.1 weight percent is required to provide the necessary suspension aid function. The upper limit for concentration of the suspension aid is dictated by the maximum thickness of the non-aqueous suspension composition that may practically be handled. It has been found that the maximum concentration of the suspension aid in the non-aqueous suspension composition should not exceed about 0.9 percent of the total weight of such composition. Thus, the concentration range for the suspension aid in the non-aqueous suspension composition can be in the range of from about 0.1 weight percent to about 0.9 weight percent. Preferably, the concentration range for the suspension aid should range from about 0.125 weight percent to about 0.7 weight percent and, most preferably, the concentration of the suspension aid should range from 0.15 weight percent to 0.35 weight percent.

It is an important aspect of the present invention for the dispersant to be added to the non-aqueous suspension. The dispersant when added in a small amount can significantly reduce the viscosity of the suspension without causing the non-soluble particles to settle. The dispersant, therefore, allows for an increase of the amount of non-soluble particles that can be added to the non-aqueous suspension composition. In addition the dispersant to the liquid suspension can also improve the stability of the non-aqueous suspension. The dispersant is selected from a group consisting of lecithin, calcium stearate, steric acid, oleic acid, palmetic acid, and other salts of fatty acids. The preferred dispersant is either calcium stearate or lecithin.

As for the concentration of the dispersant in the non-aqueous suspension composition, it must be present in the non-aqueous liquid medium in an amount and at a concentration sufficient to provide the necessary function of reducing the viscosity of the non-aqueous suspension and enhancing the stability of the suspended particles in the liquid phase of the suspension composition. It has been found that a concentration as a percentage of the total weight of the non-aqueous suspension composition of at least about 0.1 weight percent is required to provide the necessary dispersant function. It has been found that the maximum concentration of the dispersant in the non-aqueous suspension composition should not exceed about 5 percent of the total weight of such composition. Thus, the concentration range for the dispersant in the non-aqueous suspension composition can be in ranges from about 0.1 weight percent to about 5 weight percent. Preferably, the concentration for the dispersant ranges from about 0.1 weight percent to about 2 weight percent and, most preferably, the concentration of the dispersant ranges from 0.2 weight percent to 1 weight percent.

The non-aqueous liquid medium component of the non-aqueous suspension composition will generally make up the remaining portion of the non-aqueous suspension composition with a typical range of from about 30 weight percent to about 90 weight percent of the liquid suspension, preferably from about 40 weight percent to about 80 weight percent, and, most preferably, from 50 to 70 weight percent of the total weight of the non-aqueous suspension composition.

The following Table 1 summarizes the ranges of the components of the inventive non-aqueous suspension composition of the invention.

TABLE I
Typical Ranges For the Components of the Stable Liquid Suspension

| | Broad | | Most |
|---|---|---|---|
| Component | Range | Range | Preferred Range |
| Non-Soluble Particles | 10-70% | 20-60% | 30-50% |
| Suspension Aid | 0.1-0.9% | 0.125-0.7% | 0.15-0.35% |
| Non-Aqueous Liquid | 30-90% | 40-80% | 50-70% |
| Medium | | | |
| Dispersant | 0.1-5% | 0.1-2% | 0.2-1% |

The inventive non-aqueous liquid suspension can be prepared by any suitable method known in the art. The components of the inventive composition may be mixed together in any order or altogether at the same time; however, it is preferred for the suspension aid to be first dissolved or mixed with the non-aqueous liquid medium prior to the addition of the non-soluble particles to the thus-formed liquid mixture. Preferably, the dispersant is the last component added to the non-aqueous suspension.

Conditions for mixing or dissolving the suspension aid in the non-aqueous liquid medium are not a critical aspect of the invention and anyone skilled in the art may use conventional techniques for forming the solution. Generally, the temperature range for mixing the suspension aid in the non-aqueous liquid medium shall be in the range of from about 5° C. to about 100° C., but the preferred temperature range is from about 10° C. to about 60° C. and a most preferred temperature range is from about 20° C. to about 40° C.

Any standard mixing device that provides reasonably high sheer to assist in forming the solution of non-aqueous liquid medium and suspension aid can be used. The mixing time is that which is necessary to provide the desirable solution such that the suspension aid is dissolved in the non-aqueous liquid medium. Such mixing time is generally in the range of from about 0.01 hours to about 200 hours.

Once the solution of non-aqueous liquid medium and suspension aid is formed, the dispersant and the non-soluble particles are admixed to the thus-formed solution in such an amount as to provide the desirable concentration of non-soluble particles within the final non-aqueous liquid suspension composition.

The novel, non-aqueous liquid suspension described hereinabove is particularly suitable for use as an additive to water-based oil and gas oil well treatment fluids. Such well treatment fluids include, for example, stimulation fluids, fracture fluids, drilling fluids, completion fluids, and workover fluids. Typically, an oil or gas well will penetrate the surface of the earth and pass through various subterranean formations that contain deposits of natural resources such as oil and gas. Additives to the water-based fluid used either to drill or to treat wellbores or surrounding subterranean formations are used to reduce the amount of well treatment fluid that is lost to the surrounding formations or to enhance the carrying capacity or viscosity of such well treatment fluids. Thus, because of the particular properties of the inventive non-aqueous suspension described herein, it can suitably be used as an additive to oil and gas well treatment fluids by admixing with a water-based fluid in such manner as to form an admixture.

This admixture can be introduced into a wellbore thereby contacting it with the well face of the wellbore or with the subterranean formations surrounding the wellbore. Typically, the amount of non-aqueous suspension composition added to the water-based fluid shall be such as to give a weight ratio of water to additive in the range of from about 8000:1 to about 10:1. More typically, however, the ratio of water to additive in the resulting admixture of water-based fluid and additive shall range from about 3500:1 to about 20:1. Preferably, however, such ratio of water to additive shall range from 2000:1 to 40:1. The most preferred ratio of water to additive is from 1400:1 to 40:1.

The product of this invention is primarily tested by observation of the liquid suspension for stability over a wide temperature range. Stability can be measured by means of a ruler or other such graduated device whereby there is determined the thickness from the interface of the clear liquid portion of the portion of the liquid that separates from the portion of the liquid containing suspended solids.

The following specific examples are intended to illustrate the advantages of the present invention and are not intended to unduly limit the scope of the invention.

### EXAMPLES

### Example 1

### The effect of Calcium Stearate on a Particle Suspension

A base fluid was made for this suspension using 916.9 grams of di(ethylene glycol) butyl ether (Aldrich Chemical Company) and 3.68 grams of hydroxypropyl cellulose (Klucel H from Hercules). This blend was mixed for 15 minutes using a high shear blender (Charles Ross & Sons Company). This base fluid was then split into two volumes for use in the two test suspensions.

The first suspension, designated “Suspension A”, lacked any calcium stearate. It was formulated by placing 77.62 grams of the base fluid into a beaker and adding 51.76 grams of a water soluble polymer (Flowzan® Biopolymer from Drilling Specialties Company). This was mixed gently by hand until a homogeneous suspension was obtained.

For the second suspension, designated “Suspension B”, 229.93 grams of the base fluid was placed into a beaker. To that was added 153.29 grams of the Flowzan® polymer, were added, which contained calcium stearate, preblended at a concentration of 2% by weight to produce the second suspension. The concentration of calcium stearate in the second suspension was then 0.6% by weight. This, too, was mixed by hand until homogeneous.

The bulk viscosity of these suspensions was measured using a Brookfield LVDV-11 viscometer with a #3 LV disk spindle. The viscosity at 0.6 rpm spindle speed was determined by multiplying the viscometer reading by a factor of 2000, giving a value in centipoise. The reading at 12 rpm was likewise multiplied by a factor of 100, as per the manufacturer's instructions. The results of this test is detailed in Table 1.

TABLE 1
Effect of Calcium Stearate on Suspension Viscosity

| | |
|---|---|
| Calcium | Bulk Viscosity (cp) |

| | Stearate | 0.6 rpm | 12 rpm |
|---|---|---|---|
| Suspension A | 0 | 5800 | 2480 |
| Suspension B | 2600 | 2010 | |

These data show that the addition of calcium stearate resulted in a reduction of the bulk viscosity of the suspension. For this test, the addition of calcium stearate at a concentration of only 0.6% by weight led to a reduction in viscosity of over 50% in the low shear (rpm) range. At 12 rpm, the viscosity was also reduced by 19%.

### Example 2

### The effect of Calcium Stearate Concentration

A base fluid was made for this suspension using 1001.5 grams of di(ethylene glycol) butyl ether (Aldrich Chemical Company) and 5.21 grams of hydroxypropyl cellulose (Klucel H from Hercules). This blend was mixed for 15 minutes using a high shear blender (Charles Ross & Sons Company). A suspension of synthetic water soluble polymer (HE®100 from Drilling Specialties Company) was formulated by adding 45.12 grams of the polymer to 67.69 grams of the base fluid and hand mixing until a homogeneous blend was achieved. The bulk viscosity of this suspension was measured using a Brookfield LVDV-II viscometer with a #3 LV disk spindle. The viscosity at 0.6 rpm spindle speed was determined by multiplying the viscometer reading by a factor of 2000, giving an answer in centipoise. The reading at 12 rpm was likewise multiplied by a factor of 100, as per the manufacturer's instructions.

After taking the initial bulk viscosity readings, calcium stearate (Witco Corporation) was added at a concentration of 0.5% by weight to produce a first suspension. This first suspension was again mixed by hand in order to disperse the calcium stearate. The bulk viscosity was measured. This procedure was repeated to produce a second suspension having a calcium stearate concentration of 1% by weight. The results of this test are shown in Table 2.

TABLE 2
Effect of Calcium Stearate Concentration on Suspension Viscosity

| | | |
|---|---|---|
| | | Percent of |
| Calcium | Bulk Viscosity (cp) | Original Viscosity |

| Stearate | 0.6 rpm | 12 rpm | 0.6 rpm | 12 rpm |
|---|---|---|---|---|
| 0 | 42600 | 9010 | — | — |
| 0.5% | 21000 | 5990 | 49% | 66% |
| 1.0% | 18400 | 5520 | 43% | 61% |

These data clearly show that the addition of a small amount of calcium stearate can reduce the bulk viscosity of the suspension significantly. At the lower shear rate (rpm), the bulk viscosity was reduced by over half by the addition of 0.5% calcium stearate. Increasing that concentration to 1.0% produced a further, viscosity decrease. At the higher shear rate (12 rpm), the bulk viscosity showed similar reductions as a result of adding calcium stearate.

### Example 3

### The Effect of Lecithin on the Viscosity of a Particle Suspension

A base fluid was made for this suspension using 552.96 grams of di(ethylene glycol) butyl ether (Aldrich Chemical Company) and 2.22 grams of hydroxypropyl cellulose (Klucel H from Hercules). This blend was mixed for 20 minutes using a high shear blender (Charles Ross & Sons Company). This base fluid was then split into two volumes for use in the two test suspensions.

A 40% suspension of guar gum (Progum from Polypro Inc.) was made using 96.87 grams of the base fluid and 64.58 grams of guar gum. This was mixed by hand until homogeneous. After taking the viscosity measurement, as described earlier, the sample was weighed. Lecithin (Centrophase C from Central Soya Company, Inc.) was added to a concentration of 0.25% by weight. The sample was again mixed and the bulk viscosity measured. This procedure was repeated three more times adding different concentrations of lecithin. The viscosities for each of the formulations are detailed in Table 3.

| | | |
|---|---|---|
| | | Percent of |
| Lecithin | Bulk Viscosity (cp) | Original Viscosity |

| Centrophase C | 0.6 rpm | 6 rpm | 0.6 rpm | 6 rpm |
|---|---|---|---|---|
| 0 | 48000 | 19360 | — | — |
| 0.25% | 46000 | 16620 | 96% | 86% |
| 0.50% | 42600 | 14900 | 89% | 77% |
| 0.75% 34800 | 13460 | 73% | 70% | |
| 1.0% | 32200 | 12640 | 67% | 65% |

These data demonstrate that lecithin is also effective at reducing the bulk viscosity of particle suspensions, which are formulated using a thickened glycol ether as the fluid phase. The thickened glycol ether was produced by using di(ethylene glycol) butyl ether as the non-aqueous liquid medium and hydroxypropyl cellulose as a suspension aid.

That which is claimed is:

1. A non-aqueous suspension comprising:
non-soluble particles dispersed in a non-aqueous liquid medium having a concentration of a suspension aid and a dispersant wherein said non-aqueous liquid medium is selected from the group consisting of glycols, polyglycols, glycol ethers, glycol esters, and glycol ether esters and wherein said suspension aid is selected from the group consisting of hydroxypropyl cellulose, ethyl cellulose, polyvinyl pyrrolidone, polyacrylic acid and copolymers of polyvinyl pyrrolidone and acrylic acid and wherein said dispersant is selected from the group consisting of calcium sterate, lecithin, stearic acid, oleic acid, palmitic acids and other salts of fatty acids.

2. A non-aqueous suspension as recited in claim 1 wherein said non-aqueous liquid medium is selected from the group consisting of diethylene glycol, triethylene glycol, polypropylene glycol, di(ethylene glycol) ethyl ether, and di(ethylene glycol) butyl ether, and di(propylene glycol) butyl ether.

3. A non-aqueous suspension as recited in claim 2 wherein said concentration of said suspension aid is in the range of from about 0.1 to about 0.9 weight percent of the total weight of the non-aqueous suspension, and wherein concentration of said dispersant is in the range of from about 0.1% to about 5%, and wherein the amount of said non-aqueous liquid medium is the non-aqueous suspension is in the range of from about 20 weight percent to 90 weight percent of the total weight of the non-aqueous suspension.

4. A non-aqueous suspension as recited in claim 1 wherein said non-aqueous liquid medium is a polyglycol.

5. A non-aqueous suspension as recited in claim 4 wherein said concentration of said suspension aid is in the range of from about 0.1 to about 0.9 weight percent of the total weight of the non-aqueous suspension, and wherein concentration of said dispersant is in the range of from about 0.1% to about 5%, and wherein the amount of said non-aqueous liquid medium is in the non-aqueous suspension is in the range of from about 20 weight percent to 90 weight percent of the total weight of the non-aqueous suspension.

6. A non-aqueous suspension as recited in claim 1 wherein said non-soluble particles are polymeric viscosifiers selected from the group consisting of xanthan, hydroxyethyl cellulose, carboxyl methyl cellulose, guar gum, starch, derivitized guar, and various synthetic polymers and copolymers of these synthetic polymers components; and wherein said various synthetic polymers are selected from the group consisting of polyacrtlamide, and polyacrylamidomethylpropane sulphonic acid (AMPS).

7. A non-aqueous suspension as recited in claim 6 wherein said concentration of said suspension aid is in the range of from about 0.1 to about 0.9 weight percent of the total weight of the non-aqueous suspension, and wherein concentration of said dispersant is in the range of from about 0.1% to about 5%, and wherein the amount of said non-aqueous liquid medium is in the non-aqueous suspension is in the range of from about 20 weight percent to 90 weight percent of the total weight of the non-aqueous suspension.

8. A non-aqueous suspension as recited in claim 1 wherein said dispersant is calcium stearate.

9. A non-aqueous suspension as recited in claim 1 wherein said dispersant is lecithin.

10. A stable liquid suspension comprising:
a liquid phase comprising a liquid medium selected from the group consisting of glycols, polycols, glycol ethers, glycol esters and glycol ether esters;
non-soluble particles; a stabilizing amount of a suspension aid sufficient to enhance suspension of said non-soluble polymer particles in said liquid phase and a dispersant selected from the group consisting of lecithin, calcium stearate, steric acid, oleic acid, palmetic acid and other salts of fatty acids.

11. A stable liquid suspension as recited in claim 10 wherein said non-aqueous liquid medium is selected from the group consisting of diethylene glycol, triethylene glycol, polypropylene glycol, di(ethylene) glycol ethyl ether, di(ethylene) glycol butyl ether, and di(propylene glycol) butyl ether.

12. A non-aqueous suspension as recited in claim 11 wherein said concentration of said suspension aid is in the range of from about 0.1 to about 0.9 weight percent of the total weight of the non-aqueous suspension, and wherein concentration of said dispersant is in the range of from about 0.1% to about 5%, and wherein the amount of said non-aqueous liquid medium is in the non-aqueous suspension is in the range of from about 20 weight percent to 90 weight percent of the total weight of the non-aqueous suspension.

13. A stable liquid suspension as recited in claim 10 wherein said liquid medium is a polyglycol.

14. A non-aqueous suspension as recited in claim 13 wherein said concentration of said suspension aid is in the range of from about 0.1 to about 0.9 weight percent of the total weight of the non-aqueous suspension, and wherein concentration of said dispersant is in the range of from about 0.1% to about 5%, and wherein the amount of said non-aqueous liquid medium is in the non-aqueous suspension is in the range of from about 20 weight percent to 90 weight percent of the total weight of the non-aqueous suspension.

15. A stable liquid suspension as recited in claim 10 wherein said non-soluble particles are polymeric viscosifiers selected from the group consisting of xanthan, hydroxyethyl cellulose, carboxyl methyl cellulose, guar gum, starch, derivitized guar and various synthetic polymers and copolymers of these synthetic polymers components; and wherein said various synthetic polymers are selected from the group consisting of polyacrtlamide, and polyacrylamidomethylpropane sulphonic acid (AMPS).

16. A non-aqueous suspension as recited in claim 15 wherein said concentration of said suspension aid is in the range of from about 0.1 to about 0.9 weight percent of the total weight of the non-aqueous suspension, and wherein concentration of said dispersant is in the range of from about 0.1% to about 5%, and wherein the amount of said non-aqueous liquid medium is in the non-aqueous suspension is in the range of from about 20 weight percent to 90 weight percent of the total weight of the non-aqueous suspension.

17. A non-aqueous suspension as recited in claim 10 wherein said dispersant is calcium stearate.

18. A non-aqueous suspension as recited in claim 10 wherein said dispersant is lecithin.

19. A method of preparing a non-aqueous suspension, comprising the steps of:
mixing non-soluble particles, a suspension aid, a liquid medium, and a dispersant to form said non-aqueous suspension; wherein said liquid medium is selected from the group consisting of glycols, polyglycols, glycol ethers, glycol esters and glycol ether esters; and wherein said dispersant is selected from a group consisting of lecithin, calcium sterate, steric acid, oleic acid, palmitic acid and other salts of fatty acids.

20. A method as recited in claim 19 wherein said suspension aid is selected from the group consisting of hydroxypropyl cellulose, ethyl cellulose, polyvinyl pyrrolidone, polyacrylic acid and copolymers or polyvinyl pyrrolidone and acrylic acid.

21. A method as recited in claim 19 wherein said non-aqueous liquid medium is a polyglycol.

22. A non-aqueous suspension as recited in claim 2 wherein said concentration of said suspension aid is in the range of from about 0.1 to about 0.9 weight percent of the total weight of the non-aqueous suspension, and wherein concentration of said dispersant is in the range of from about 0.1% to about 5%, and wherein the amount of said non-aqueous liquid medium is in the non-aqueous suspension is in the range of from about 20 weight percent to 90 weight percent of the total weight of the non-aqueous suspension.

23 A method as recited in claim 19 wherein said dispersant is calcium stearate.

24. A non-aqueous suspension as recited in claim 2 wherein said concentration of said suspension aid is in the range of from about 0.1 to about 0.9 weight percent of the total weight of the non-aqueous suspension, and wherein concentration of said dispersant is in the range of from about 0.1% to about 5%, and wherein the amount of said non-aqueous liquid medium is in the non-aqueous suspension is in the range of from about 20 weight percent to 90 weight percent of the total weight of the non-aqueous suspension.

25. A method as recited in claim 19 wherein said dispersant in lecithin.

26. A non-aqueous suspension as recited in claim 25 wherein said concentration of said suspension aid is in the range of from about 0.1 to about 0.9 weight percent of the total weight of the non-aqueous suspension, and wherein concentration of said dispersant is in the range of from about 0.1% to about 5%, and wherein the amount of said non-aqueous liquid medium is in the non-aqueous suspension is in the range of from about 20 weight percent to 90 weight percent of the total weight of the non-aqueous suspension.

27. A method as recited in claim 16 wherein said non-soluble particles are polymeric viscosifiers selected from the group consisting of xanthan, hydroxyethyl cellulose, carboxyl methyl cellulose, guar gum, starch, derivitized quar and various synthetic polymers and copolymers of these synthetic polymers components; and wherein said various synthetic polymers are selected from the group consisting of polyacrtlamide, and polyacrylamidomethylpropane sulphonic acid (AMPS).

28. A non-aqueous suspension as recited in claim 27 wherein said concentration of said suspension aid is in the range of from about 0.1 to about 0.9 weight percent of the total weight of the non-aqueous suspension, and wherein concentration of said dispersant is in the range of from about 0.1% to about 5%, and wherein the amount of said non-aqueous liquid medium is in the non-aqueous suspension is in the range of from about 20 weight percent to 90 weight percent of the total weight of the non-aqueous suspension.

29. A method as recited in claim 19 wherein said non-aqueous liquid medium is selected from the group consisting of diethylene glycol, triethylene glycol, polypropylene glycol, di(ethylene glycol) ethyl ether, and di(ethylene glycol) butyl ether.

30. A non-aqueous suspension as recited in claim 29 wherein said concentration of said suspension aid is in the range of from about 0.1 to about 0.9 weight percent of the total weight of the non-aqueous suspension, and wherein concentration of said dispersant is in the range of from about 0.1% to about 5%, and wherein the amount of said non-aqueous liquid medium is in the non-aqueous suspension is in the range of from about 20 weight percent to 90 weight percent of the total weight of the non-aqueous suspension.

31. A method of preparing a non-aqueous liquid suspension, said method comprises the steps of:
mixing nonsoluble particle with a liquid medium and adding thereto a stabilizing amount of a suspension aid sufficient to enhance the suspension of said non-soluble particles in said liquid medium, and adding thereto an adequate amount of dispersant to decrease the viscosity of said non-aqueous liquid suspension.

32. A method as recited in claim 31 wherein said suspension aid is selected from the group consisting of hydroxypropyl cellulose, ethyl cellulose, polyvinyl pyrrolidone, polyacrylic acid and copolymers of polyvinyl pyrrolodone and acrylic acid.

33. A non-aqueous suspension as recited in claim 32 wherein said concentration of said suspension aid is in the range of from about 0.1 to about 0.9 weight percent of the total weight of the non-aqueous suspension, and wherein concentration of said dispersant is in the range of from about 0.1% to about 5%, and wherein the amount of said non-aqueous liquid medium is in the non-aqueous suspension is in the range of from about 20 weight percent to 90 weight percent of the total weight of the non-aqueous suspension.

34. A method as recited in claim 32 wherein said non-aqueous liquid medium is a polyglycol.

35. A non-aqueous suspension as recited in claim 34 wherein said concentration of said suspension aid is in the range of from about 0.1 to about 0.9 weight percent of the total weight of the non-aqueous suspension, and wherein concentration of said dispersant is in the range of from about 0.1% to about 5%, and wherein the amount of said non-aqueous liquid medium is in the non-aqueous suspension is in the range of from about 20 weight percent to 90 weight percent of the total weight of the non-aqueous suspension.

36. A method as recited in claim 33 wherein said non-soluble particle are polymeric viscosifiers selected from the group consisting of xanthan, hydroxyethyl cellulose, carboxyl methyl cellulose, guar gum, starch, derivitized guar and polyacrylamide.

37. A non-aqueous suspension as recited in claim 2 wherein said concentration of said suspension aid is in the range of from about 0.1 to about 0.9 weight percent of the total weight of the non-aqueous suspension, and wherein concentration of said dispersant is in the range of from about 0.1% to about 5%, and wherein the amount of said non-aqueous liquid medium is in the non-aqueous suspension is in the range of from about 20 weight percent to 90 weight percent of the total weight of the non-aqueous suspension.

38. A method as recited in claim 34 wherein said non-aqueous liquid medium is selected from the group consisting of diethylene glycol, triethylene glycol, polypropylene glycol, di(ethylene glycol) ethyl ether, di(ethylene glycol) butyl ether, and di(propylene glycol) butyl ether.

39. A non-aqueous suspension as recited in claim 38 wherein said concentration of said suspension aid is in the range of from about 0.1 to about 0.9 weight percent of the total weight of the non-aqueous suspension, and wherein concentration of said dispersant is in the range of from about 0.1% to about 5%, and wherein the amount of said non-aqueous liquid medium is in the non-aqueous suspension is in the range of from about 20 weight percent to 90 weight percent of the total weight of the non-aqueous suspension.

40. A method of treating an oil or gas well or any surrounding subterranean formation adjacent thereto, said method comprises the steps of:
admixing the composition of claim 1 with the water based fluid; and introducing the thus-formed admixture into a well bore.

41 A method of treating an oil or gas well or any surrounding subterranean formation adjacent thereto, said method comprises the steps of:
admixing the composition of claim 1 with the water based fluid; and introducing the thus-formed admixture into a well bore.
